(19) United States
(12) Patent Application Publication
(10) Pub. No.: US 2015/0135897 A1
(43) Pub. Date: May 21, 2015

(54) MANUFACTURE OF METAL ARTICLES

(71) Applicant: RENISHAW PLC, Wotton-under-Edge, Gloucestershire (GB)

(72) Inventors: Christopher John Sutcliffe, South Liverpool (GB); Peter Fox, Liverpool (GB)

(21) Appl. No.: 14/402,486

(22) PCT Filed: May 28, 2013
(86) PCT No.: PCT/GB2013/051405

§ 371 Date: Nov. 20, 2014

(30) Foreign Application Priority Data
May 28, 2012 (GB) 1209415.7

(51) Int. Cl. B22F 3/105; B23K 26/34; B65D 85/00; B23K 15/00; B23K 15/10; C22C 21/00; B23K 26/12

(52) U.S. Cl. CPC B22F 3/1055; C22C 21/00; B23K 26/345; B23K 26/12; B23K 15/0086; B23K 15/10; B65D 85/70; B33Y 10/00
USPC 75/249; 419/1; 419/57; 420/554; 219/76.14; 219/74; 206/524.1; 206/6

(57) ABSTRACT

The disclosure relates to the manufacture of metal articles, more specifically the manufacture of metal articles by additive manufacturing techniques, and in particular to the manufacture of metal articles by an additive manufacturing technique that may involve the selective melting or sintering of a metal powder. Examples of such techniques may include selective laser melting (SLM), selective laser sintering (SLS) and techniques that use an electron beam rather than a laser. Exemplary embodiments include a method of manufacture of an article including selective melting and/or sintering of a powder including an alloy containing aluminium, wherein the alloy contains bismuth.

The present invention relates to the manufacture of metal articles, more specifically the manufacture of metal articles by additive manufacturing techniques. In particular, the invention relates to the manufacture of metal articles by an additive manufacturing technique that may involve the selective melting or sintering of a metal powder. Examples of such techniques may include selective laser melting (SLM), selective laser sintering (SLS) and techniques that use an electron beam rather than a laser.

Selective laser melting (SLM) is a rapid prototyping (RP) and/or rapid manufacturing (RM) technology which may be used for the production of metallic solid and porous articles. Conveniently, the articles may have suitable properties to be put straight in to use. For instance, SLM may be used to produce one-off articles such as parts or components which are bespoke to their intended application. Similarly, SLM may be used to produce large or small batches of articles such as parts or components for a specific application.

SLM builds articles in a layer-by-layer fashion. Typically, this requires thin (e.g. from 20 μm to 100 μm) uniform layers of fine metal powders to be deposited on a moving substrate. The powder particles are then fused together by selectively laser scanning them, usually according to a model's 3D CAD data.

SLM relies on converting a powder into a melt pool, from which material solidifies to form a new solid component. The solid weld bead must also fuse to the underlying and surrounding solid if a dense, strong component is to be produced.

An advantage of SLM, particularly in comparison with powder sintering used in some other RP/RM processes, is complete metal powder melting which may lead to higher densities and better mechanical properties. Further, this may reduce or even eliminate the need for binders and/or for post-processing.

In addition, additive manufacturing techniques such as SLM or SLS typically may be more cost effective and/or time effective for making articles having more complex geometries when compared with conventional manufacturing techniques, due to the absence of any tooling. There may also be a significant reduction in design constraints. The production of fully functional parts directly from metal powders that can be used in place of parts that would normally be machined or cast is one reason for the widening application of additive manufacturing techniques such as SLM or SLS, e.g. in the medical, dental, aerospace and electronics sectors.

The production of articles using additive manufacturing techniques such as SLM or SLS often requires the use of fine powders of reactive metals. These powders can present significant handling problems, both from a safety perspective and from a materials processing perspective. Typically, therefore, these powders are stored and used under protective atmospheres. This may help improve the spreading of the powder to form the thin powder layer, reduce fire and health risks from the fine powders and may minimise or at least reduce the formation of oxides and hydrates that may affect part integrity.

SLM has been used to produce 100% dense stainless steel and titanium parts and these parts typically can reliably reproduce the properties of bulk materials.

However, SLM has yet to work as well with aluminium and alloys containing aluminium. In particular, it is difficult to manufacture aluminium or aluminium alloy articles having densities approaching 100% theoretical density. Typically, problems may arise due to the formation of thin adherent oxide films on the surfaces of both molten and solid aluminium alloys. These surface oxide films modify the wetting behaviour of both the solid and the liquid.

Louvis et al (Louvis, E., Fox, P. and Sutcliffe, C. J., 2011. Selective laser melting of aluminium components. Journal of Materials Processing Technology, vol. 211, no. 2, pp. 275-284) found that the high degree of porosity seen in aluminium SLM parts is mainly due to the formation of oxide films. This work used relatively low laser powers (50 W and 100 W).

Theoretically, it may be possible to reduce the problems associated with surface oxide films by significantly increasing the laser power to heat the material to a temperature high enough to decompose the oxide and/or to carry out SLM in an atmosphere having a low enough oxygen content to stop the oxide forming.

Sarou-Kanian et al (Sarou-Kanian, V., Millot, F. and Rifflet, J. C., 2003. Surface Tension and Density of Oxygen-Free Aluminium at High Temperature. International Journal of Thermophysics, vol. 24, no. 1, pp. 277-286) reported that temperatures in excess of 1327° C. are necessary to decompose the oxide. Schleifenbaum et al (Schliefenbaum, H., Meiners, W., Wissenbach, K. and Hinke, C., 2010. Individualized Production by Means of High Power Selective Laser Melting. CIRP Journal of Manufacturing Science and Technology, vol. 2, no. 3, pp. 161-169) reported that a laser power of 330 W was necessary for producing high quality aluminium components by SLM.

While it may be possible to obtain articles having satisfactory quality and mechanical properties comparable to those of a cast or machined aluminium component by using more powerful lasers to superheat the material, there are attendant problems in terms of cost and/or of loss of control of the process, as the melt pool sizes increases.

Reducing the oxygen content of the atmosphere to a low enough level to stop the oxide forming may also be so costly and difficult as to be impractical and/or unfeasible in any commercial manufacturing process. For instance, the partial pressure of oxygen pO₂ would have to be less than 10⁻⁵² atmospheres at 600° C.

Moreover, aluminium oxidation during SLM or SLS may be unavoidable even under the most well controlled process conditions as it can even occur because of the oxygen within the powder particles.

A first aspect of the invention provides a method of manufacture of an article comprising selective melting and/or sintering of a powder comprising an alloy containing aluminium, wherein the alloy contains bismuth, preferably in an amount up to 10 wt %.

Preferably, an electron beam or a laser may be used to selectively melt and/or sinter the powder.

The method may comprise selective laser melting (SLM) and/or selective laser sintering (SLS).

Aluminium may be a major component of the alloy.

Preferably, the alloy may contain no more than 5 wt % bismuth. More preferably, the alloy may contain no more than 4 wt % bismuth.

Preferably, the alloy may contain at least 0.2 wt % bismuth.

Preferably, the alloy may contain bismuth in an amount equal to or approaching its maximum liquid solubility in the alloy.

The alloy may be an aerospace alloy, a casting alloy or a wrought alloy.

Preferably, the alloy may be an aluminium-silicon alloy.

Preferably, the alloy contains scandium. The alloy may be an aluminium-magnesium-scandium-bismuth alloy.

The aluminium alloy may contain magnesium in an amount up to around 4.3% by weight, and optionally between 1.8 and 4.3% by weight. The alloy may contain scandium in an amount up to around 1.4% by weight, and optionally between 0.7 and 1.4% by weight. The alloy may further contain zirconium in an amount up to around 0.55% by weight, and optionally between 0.22 and 0.55% by weight. The alloy may further contain manganese in an amount up to around 0.7% by weight, and optionally between 0.3 and 0.7% by weight.

Preferably, the alloy may be a eutectic or near eutectic alloy.

The alloy may be a 6061 alloy or an AlSi12 alloy.

Typically, the selective melting and/or sintering may be carried out under an inert environment. The inert environment under which the selective melting and/or sintering is carried out may be argon-based or nitrogen-based. Preferably, the inert environment may contain no more than 0.2 vol % oxygen.

A laser or electron beam power of 200 W or less, preferably 150 W or less, more preferably 100 W or less, may be used.

Preferably, the laser or electron beam power may be 50 W or more.

Typically, the laser or electron beam power may be 50 W or 100 W.

Preferably, the laser or electron beam may have a beam spot diameter of 100 μm or less. For instance, the beam spot diameter may be 50 μm or less. The beam spot diameter may be 5 μm or more, e.g. 10 μm or more.

Preferably, the laser or electron beam may follow a meander pattern. A laser or electron beam scanning speed of no more than 400 mm/s, preferably no more than 200 mm/s, may be used. Preferably, the laser or electron beam scanning speed may be 100 mm/s or more.

A hatch distance of at least 0.05 mm may be used. The hatch distance may be up to 1 mm, e.g. up to 0.5 mm or up to 0.3 mm. For instance, the hatch distance may be 0.1 mm, 0.15 mm or 0.2 mm.

A layer thickness of up to 0.5 mm may be used. Typically, a layer thickness of up to 100 μm may be used. The layer thickness may be 1 μm or more, e.g. 20 μm or more. For instance, the layer thickness may be 50 μm or more.

The powder may have an average particle size, e.g. average diameter, of less than 1 μm or at least 1 μm, e.g. at least 5 μm or at least 10 μm, preferably at least 20 μm. The powder may have an average particle size, e.g. average diameter, of up to 100 μm, preferably up to 80 μm or up to 50 μm. For instance, the powder may have an average particle size, e.g. average diameter, of 45 μm.

Preferably, the method may comprise the preliminary step of producing the powder. The powder may be produced by atomisation. Advantageously, atomisation typically may produce substantially spherical particles.

Preferably, the method may be controlled in accordance with input data. Typically, the input data may comprise geometrical data, e.g. geometrical data stored on a CAD file. Additionally or alternatively, the input data may comprise one or more predetermined laser or electron beam scanning parameters.

The article may have a density of at least 85%, preferably at least 90%, more preferably at least 95%, most preferably at least 98%, theoretical density. Preferably, the article may have a density approaching 100% theoretical density, e.g. the article may be substantially fully dense.

The article may be a component or part for use in a complex product or device. Alternatively, the article may be a product or device.

Another aspect of the invention provides an article manufactured according to the method of the first aspect of the invention.

Another aspect of the invention provides powder for use in a method of manufacture of an article comprising selective melting and/or sintering of the powder, the powder comprising an alloy containing aluminium, wherein the alloy contains bismuth, preferably in an amount up to 10 wt %.

Another aspect of the invention provides a storage container connectable to an additive manufacturing apparatus, e.g. a selective laser melting apparatus or a selective laser sintering apparatus, the container containing a powder according to the invention. Typically, the container may also contain an inert gas such as argon, as the powder my be explosive in the presence of oxygen.

Typically, the container may be connectable to the apparatus such that, in use, the powder may flow from the container into a powder dispensing mechanism within the apparatus.

In order that the invention may be well understood, it will now be described, by way of example only, with reference to the accompanying drawings, in which:

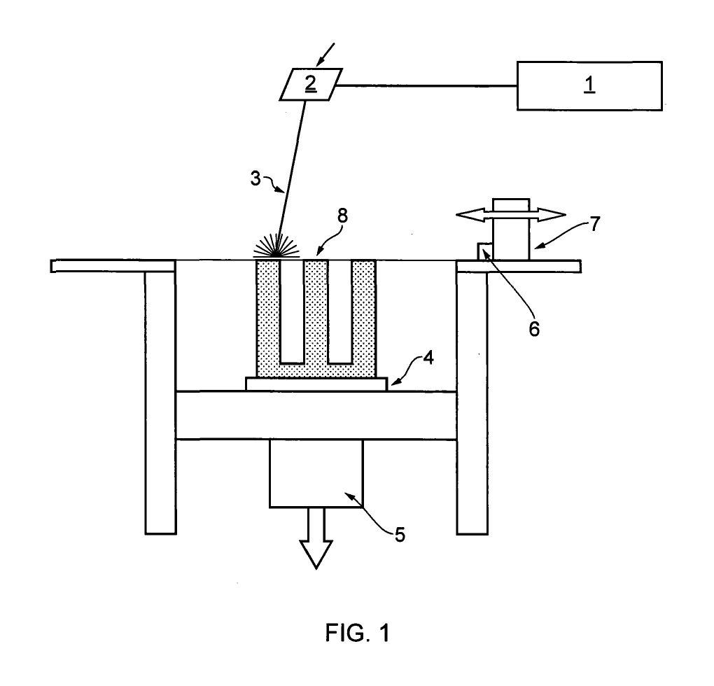

FIG. 1 illustrates a typical SLM process and apparatus;

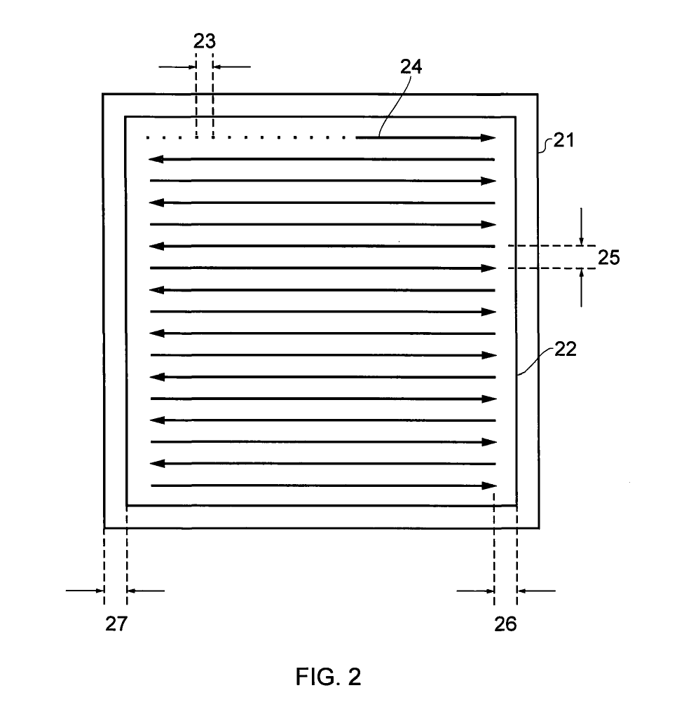

FIG. 2 illustrates some of the main laser scanning parameters;

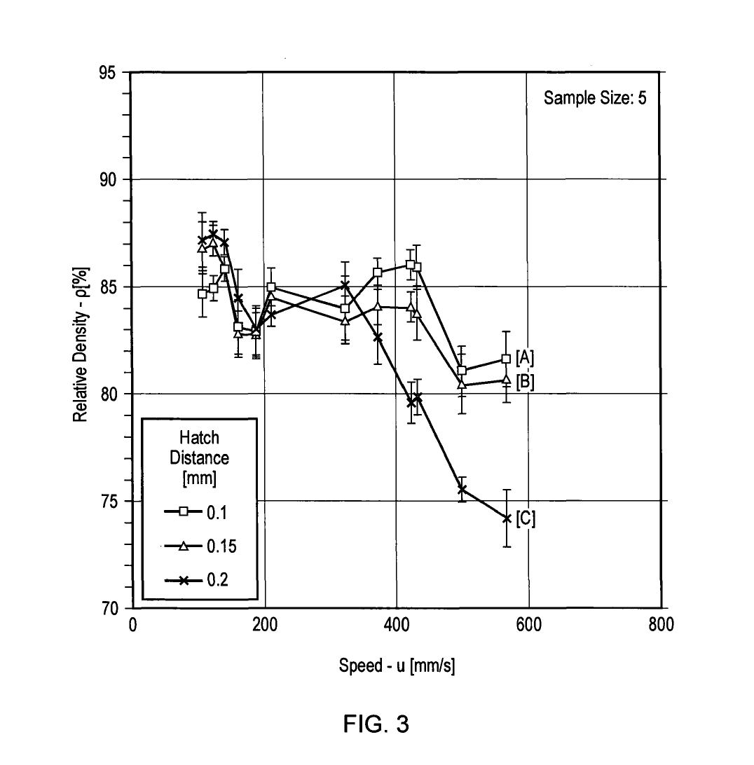

FIG. 3 is a graph showing the effect of laser scanning speed and hatch distance on the resulting relative density of 6061-Bi at 100 W laser power;

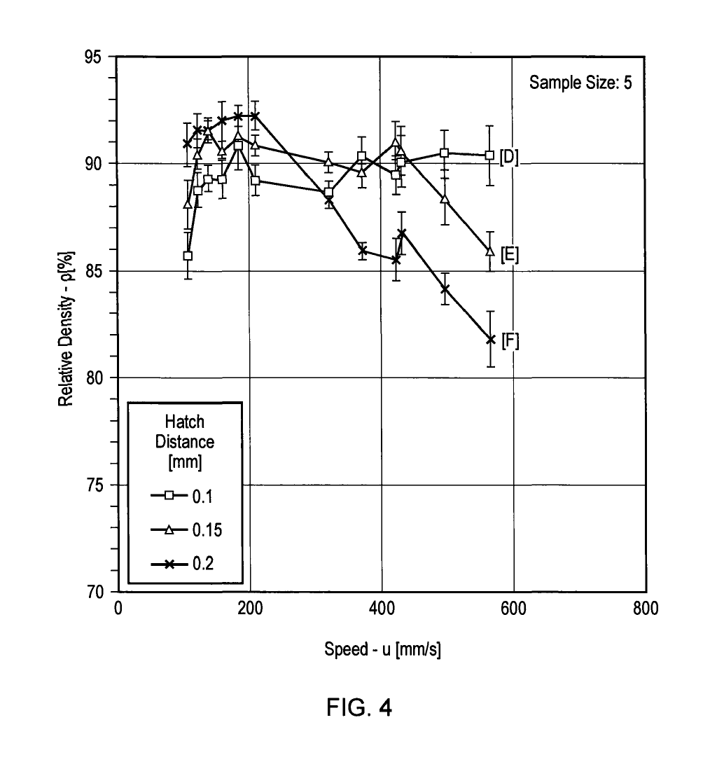

FIG. 4 is a graph showing the effect of laser scanning speed and hatch distance on the resulting relative density of AlSi12-Bi at 100 W laser power;

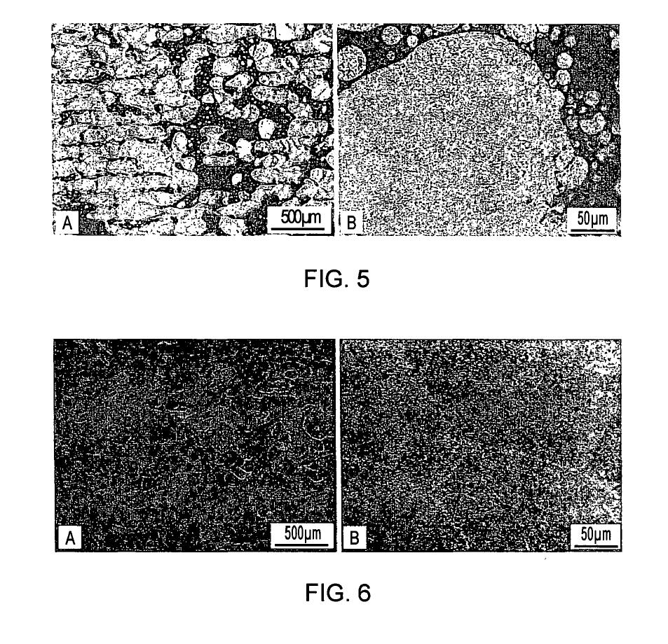

FIG. 5 shows a pair of optical micrographs of an XY section of a 6061-Bi sample;

FIG. 6 shows a pair of optical micrographs of an XY section of an AlSi12-Bi sample; and

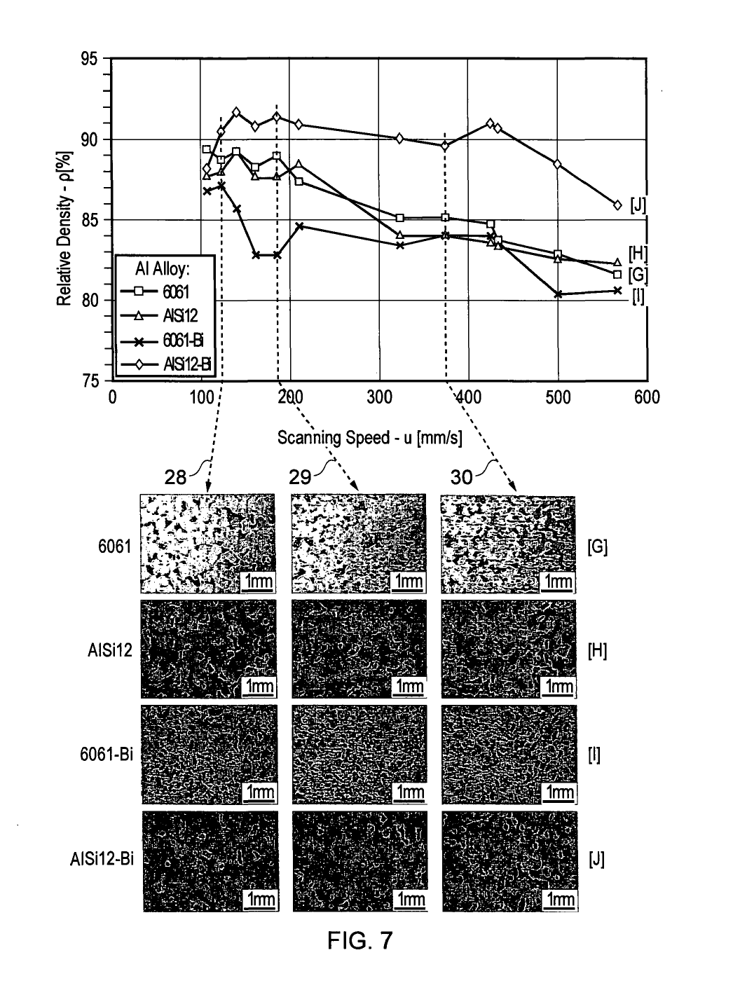

FIG. 7 includes a graph and optical micrographs comparing alloys' relative density at 100 W laser power and 0.15 mm hatch distance.

Experimental specimens were produced using two MCP Realizer SLM100 machines (MTT Tooling Technologies, UK) having maximum laser powers of 50 W and 100 W.

FIG. 1 schematically shows the SLM process and apparatus. The apparatus comprises a ytterbium fibre laser 1, which emits a laser beam 3. One or more scanning mirrors 2 serve to direct the laser beam 3 on to the powder. The powder is provided on a base plate 4 which can be moved up and down by operation of a piston 5. A powder deposition or recoating mechanism 7 for depositing the powder in layers during the SLM process comprises a wiper blade 6.

In use, powder layers are uniformly spread on a substrate provided on the base plate 4 using the powder deposition mechanism 7. The powder deposition mechanism 7 is custom made to be suitable for use with aluminium powders. Each layer is scanned with the ytterbium fibre laser beam 3 (wavelength (λ)=1.06 μm, beam spot diameter=80 μm) according to CAD data. The melt powder particles fuse together (a solidified portion is indicated at 8), forming a layer of the article or part, and the process is repeated until the top layer. The article or part is then removed from the substrate and any unfused powder can be reused for the next build. The process is performed under an inert environment, which is normally argon, while the oxygen level is typically 0.1-0.2 vol %. During the SLM process, the chamber atmosphere, which is kept at an overpressure of 10-12 mbar, is continuously recirculated and filtered.

The input data for making a part comprise geometrical data stored as a CAD file and the laser scanning process parameters. The main process parameters which may affect the density of aluminium SLM parts include: laser power; the laser scanning speed which depends on the exposure time on each of the laser spots that constitute the scanned path, and the distance between them (point distance); and the distance between the laser hatches.

FIG. 2 illustrates some of the main laser scanning parameters. The arrows indicate a laser scanning pattern across a sample. FIG. 2 shows a boundary 21, inside which there is a fill contour 22. A fill contour offset 27 constitutes the distance between the boundary 21 and the fill contour 22. The laser scanning pattern covers substantially all of the sample within the fill contour 22. The laser scanning pattern constitutes a path (indicated by the arrows) made up of a series of laser spots. For illustrative purposes a few of these laser spots are shown individually in the top line of the laser scanning pattern. The distance from a given laser spot to the next laser spot in the sequence is known as the point distance 23. Each line within the laser scanning pattern is known as a hatch 24. The laser scanning pattern illustrated in FIG. 2 comprises 17 substantially parallel hatches; the laser scans in a first direction along a first hatch, then in a second opposite direction along a second hatch, then in the first direction along a third hatch, then in the second opposite direction along a fourth hatch and so on. The distance from an end of a hatch 24 to the fill contour 22 is known as the hatch offset 26. The distance between one hatch and the next hatch in the sequence, e.g. between a sixth hatch and a seventh hatch, is known as the hatch distance 25.

In the applicant's experiments, cubic specimens having a side length of 10 mm were built using combinations of the parameters. Relative densities of the specimens were determined gravimetrically.

The laser followed a meander pattern (the pattern shown in FIG. 2 is an example of a meander pattern), while the scanning direction was kept the same for every layer in order to make the scan tracks easier to observe.

A layer thickness of 50 μm was typically used. This thickness was chosen, because it allowed the use of powders having an average particle diameter of 45 μm. This particle size was preferred, because it does not jam up the dispensing mechanism used in the applicant's experiments. Other particle sizes may be used with other dispensing mechanisms. Furthermore, increasing layer thicknesses can lead to poor interlayer bonding and/or deterioration in the balling effect.

The substrate of the specimens was heated to 180° C. during laser processing.

The experiments were carried out in an argon atmosphere, typically containing 0.1-0.2 vol % oxygen. Other protective atmospheres could have been used, e.g. nitrogen.

Bismuth was added to two aluminium alloys, 6061 and AlSi12. Oversaturated alloys were initially produced. These two master alloys (1 kg each) were mixed with 6061 and AlSi12 ingots (5 kg) respectively prior to atomization. Atomisation was carried out by CERAM, UK. The alloys before atomisation contained bismuth in an amount below the liquid solubility limit and so only one liquid formed within the sprayer. As is it possible that an amount of bismuth could be lost during atomisation, quantitative elemental analysis of the powder was carried out by inductively coupled plasma optical emission spectroscopy (ICP-OES). This showed that 6061-Bi contained 2.5 wt % Bi and AlSi12-Bi contained 2.8 wt % Bi.

The optical micrographs shown in FIGS. 5, 6 and 7 were obtained using a Nikon Epiphot optical microscope after polishing the specimens down to 20 nm (Metasery Universal Polisher). The polished specimens were subsequently etched with Keller's reagent (aqueous solution of 1 vol % hydrogen fluoride, 1.5 vol % hydrochloric acid and 2.5 vol % nitric acid) in order to reveal their microstructure.

The effect of bismuth on the density was evaluated by altering the main process parameters and showing in graphs the relationship between them. Metallographic analysis of the specimens' sections revealed any microstructure differences of the modified alloys and the way these affected the oxidation problem of aluminium alloys.

FIG. 3 is a graph showing some results for 6061-Bi samples produced by SLM using 100 W laser power. Relative density measured as a percentage of the theoretical density of 6061-Bi is plotted on the y-axis; laser scanning speed measured in mm/s is plotted on the x-axis. Three data series are shown on the graph. A first data series [A] is for samples made using a hatch distance of 0.1 mm, a second data series [B] is for samples made using a hatch distance of 0.15 mm and a third data series [C] is for samples made using a hatch distance of 0.2 mm.

In the applicant's initial experiments, the relative density of 6061-Bi samples did not show a significant increase, as compared with the maximum relative density (89.5%) of 6061 achieved at the same processing conditions.

FIG. 4 is a graph showing some results for AlSi12-Bi samples produced by SLM using 100 W laser power. Relative density measured as a percentage of the theoretical density of AlSi12-Bi is plotted on the y-axis; laser scanning speed measured in mm/s is plotted on the x-axis. Three data series are shown on the graph. A first data series [D] is for samples made using a hatch distance of 0.1 mm, a second data series [E] is for samples made using a hatch distance of 0.15 mm and a third data series [F] is for samples made using a hatch distance of 0.2 mm.

In the applicant's initial experiments, the relative density of AlSi12-Bi samples did showed a significant increase, as compared with the maximum relative density achieved at the same processing conditions.

Moreover, when bismuth was added to a near-eutectic aluminium-silicon alloy (AlSi12-Bi), the SLM parts produced showed a higher relative density than any of the other alloys tested by the applicant (see FIG. 7, discussed below).

FIG. 5 is a pair of optical micrographs of a section of a 6061-Bi sample. The right hand image is a higher magnification view of a portion of the left hand image.

FIG. 6 is a pair of optical micrographs of a section of an AlSi12-Bi sample. The right hand image is a higher magnification view of a portion of the left hand image.

The porosity of the 6061-Bi and AlSi12-Bi samples can be seen in the micrographs in FIGS. 5 and 6. In general, all pores have irregular shapes with sharp edges, which is indicative of the oxides formed around them. In FIG. 6, it is notable that the grains at the edges of the consecutive microwelds are relatively larger than the rest areas. This grain growth is probably a result of the lower temperature and the lower cooling rate at the melt pool boundaries, as well as due to heating twice the overlapping areas of neighbouring meltpools.

FIG. 7 provides a comparison of the relative densities of 6061, AlSi12, 6061-Bi and AlSi12-Bi samples produced using the same SLM processing conditions (100 W laser power and 0.15 mm hatch distance). Relative density measured as a percentage of the theoretical density of the alloy is plotted on the y-axis; laser scanning speed measured in mm/s is plotted on the x-axis. Four data series are shown on the graph. A first data series [G] is for 6061 samples, a second data series [H] is for AlSi12 samples, a third data series [I] is for 6061-Bi samples and a fourth data series [J] is for AlSi12-Bi samples.

Optical micrographs of sections, parallel to the scanned layers, of the four materials are shown underneath the graph for samples produced at three laser scanning speeds. The laser scanning speeds, 120 mm/s, 190 mm/s and 380 mm/s, are indicated by dashed lines 28, 29 and 30 respectively.

The applicants have found that bismuth may have a significant impact on the relative density of aluminium and aluminium alloy articles, parts or components produced by SLM. For instance, referring to FIG. 7, a comparison of the bismuth-containing alloy AlSi12-Bi with the alloy AlSi12 at 100 W laser power and at the best hatch distance (which was found to be 0.15 mm), shows clearly the advantage of the bismuth addition, especially at higher scanning speeds. Thus, the beneficial effect of bismuth on relative density may be observed in SLM processing of eutectic or near eutectic aluminium-silicon alloys. However, it is anticipated that the benefits may be realised in other aluminium alloy systems.

Sections, parallel to the scanned layers, of these four materials were compared using the optical microscope. Optical micrographs are shown in FIG. 7. The selected specimens were made using three different laser scanning speeds (120 mm/s, 190 mm/s and 380 mm/s, indicated in FIG. 7 by the dashed lines 28, 29 and 30 respectively). These sections could be anywhere within the 50 μm distance of two consecutive layers. As a small periodical variability of the porosity is expected at every 25 microns which is the distance between the middle of a layer and its border with the next one, the porosity shown in these micrographs may not be entirely representative of the specimens' one. Nevertheless, the porosity shown in the micrographs is likely to be indicative. The gravimetric method may be used to obtain a more accurate determination of the relative density of the materials. The gravimetric method was used to determine the relative densities plotted in the graph shown in the top half of FIG. 7.

From the micrographs shown in FIG. 7, it can be seen that the AlSi12-Bi specimens that were made using slow scanning speeds clearly have a denser structure.

Without wishing to be bound by any theory, it is postulated that there may be two ways that bismuth may facilitate SLM processing of aluminium alloys. Bismuth may act to weaken the oxide films making them easier to break up. Bismuth may also increase the fluidity of the alloys thereby potentially increasing the stirring of the melt pool.

The effect of bismuth on fluidity may be due to segregation of bismuth to the metal oxide interface, where it may weaken the oxide and its bond to the underlying metal. Another possible effect is that the layer of bismuth, which forms a less stable oxide, may cover the surface of the molten aluminium, hindering oxygen movement to the aluminium, and may thus slow down the formation of aluminium oxide film. Whatever effect is occurring, it will alter the oxide films and so affect the surface tension of the molten alloy.

It can be derived, that during the SLM of bismuth-containing alloys, the melt pool's surface tension drops. Its contact angle with the surrounding solidified material may therefore reduce. As this promotes better wetting, it may result in more dense parts, at low laser energy densities.

Theoretically, there may be a limit of the beneficial action of bismuth, which may be related with the alloy's melting point. For instance, when the laser scanning generates temperatures within the sintering range, bismuth may not be expected to affect the porosity so intensely. AlSi12 has a much lower melting point than 6061 and this might explain why bismuth had a more noticeable effect on the eutectic aluminium-silicon alloy (AlSi12) than on 6061 at 100 W laser power. A possible decreased oxide film thickness of the AlSi12-Bi alloy may also have facilitated the diffusion of the aluminium atoms through it. This may have induced the sintering of unmelted powder particles on the walls of the produced specimens.

The aluminium-bismuth phase diagram shows that the solid solubility of bismuth in solid aluminium is negligible. However, its maximum liquid solubility at the monotectic temperature (657° C.) is 3.4 wt % and any further addition would lead to the formation of two immiscible liquid phases of different compositions. When a hypo-monotectic Al—Bi alloy freezes the bismuth is rejected from the solid both to any surfaces and to form liquid globules within the alloy. At temperatures below its melting point (270° C.) the bismuth solidifies forming pure particles of bismuth within the aluminium alloy.

The addition of bismuth at amounts below its liquid solubility on aluminium alloys resulted in the reduction of the oxide defects and in the relative density increase. Without wishing to be bound by any theory, this may have been due to the formation of weaker oxides that can break up more easily under the effect of Marangoni flow, but may also be a result of enhancing the liquid flow itself. When tested under 100 W laser power, bismuth led to significant porosity reduction for the AlSi12 alloy. Better results may be expected when using bismuth's maximum solubility in AlSi12, after confirming its uniform distribution in the powder, and when SLM processing this alloy at lower oxygen levels. Under these conditions, determination of the minimum laser energy density for the production of near fully dense components could show the full extent of bismuth's beneficial effect but it may also reveal other possible factors for porosity in aluminium alloys such as the effect of moisture.

A powder for use in the method of manufacture may be supplied in a storage container. Typically, the container may also contain an inert gas such as argon. Advantageously, the storage container may be connectable to a powder dispensing mechanism of an SLM apparatus.

Advantageously, the invention may provide for the prototyping and/or manufacture, e.g. mass manufacture, batch manufacture or one-off manufacture, by an additive manufacturing technique such as SLM or SLS of aluminium-containing articles having higher densities and/or better mechanical properties, e.g. higher strengths, and/or better surface finishes than has previously been achievable.

Furthermore, the invention may allow for the prototyping and/or manufacture, e.g. mass manufacture, batch manufacture or one-off manufacture, by an additive manufacturing technique of aluminium-containing articles having higher densities and/or better mechanical properties, e.g. higher strengths, and/or better surface finishes than has previously been achievable without using very high laser or electron beam powers.

Other alloys for which the addition of bismuth is expected to show a benefit include the following aluminium alloys. Bismuth may be added to these alloys in the proportions indicated above, for example by replacing a part of the balance of aluminium with bismuth, and thereby maintaining the proportions of the alloying elements in those indicated, or by adding an amount of bismuth to the alloy made to the proportions indicated in the table below, thereby reducing the proportions accordingly. For example, adding Bi to alloy A357 to result in 2 wt % Bi in the final composition and maintaining the relative proportions of the existing alloying components Si, Ti and Mg to Al results in a reduction by 0.98 of the proportion of Si from 7% to 6.86%, Mg from 0.5% to 0.49% and Ti from 0.15% to 0.147%, leaving the balance of Al being 90.503% (from 92.35%).

| | Proportions/wt. % | | | | | | | | | | | |
|---|---|---|---|---|---|---|---|---|---|---|---|---|
| Alloy | Al | Cu | Zn | Si | Ni | Fe | Ti | Mg | Cr | Sc | Zr | Mn |
| A357 | Bal | | | 7 | | | 0.15 | 0.5 | | | | |
| 7075 | Bal | 1.6 | 5.6 | 0.07 | | 0.1 | | 2.5 | 0.3 | | | |
| 2618 | Bal | 2.3 | | | 1 | 1.1 | 0.07 | 1.6 | | | | |
| Scalmalloy | Bal | | | | | | | 1.8-4.3 | | 0.7-1.4 | 0.22-0.55 | 0.3-0.7 |

The alloy Scalmalloy, an aluminium-magnesium-scandium alloy with minor proportions of zirconium and manganese (Scalmalloy is a registered trade mark of EADS Deutschland GmbH) offers enhanced strength and corrosion resistance, with good fatigue and toughness properties. However, because of the balling problem it is not easy to create parts that are 100% dense using selective laser melting. As a result, any increase in strength tends to be countered by a reduction in strength because the part formed using SLM is not fully dense, the effect being that the strength is not necessarily comparable to an Al part manufactured using a different method. The addition of bismuth allows a 100% dense part to be created, for the reasons already set out above in relation to other aluminium alloys. Accordingly, this allows the above stated advantages of this particular alloy to be more fully realised.

Articles made in accordance with the invention may be especially suitable for use in applications that require lubrication, for example bearing applications. Articles made in accordance with the invention may be self lubricating.

Articles made in accordance with the invention may be used as parts or components in a wide range of industries including the medical, dental, computing, electronics, automotive and aerospace sectors.

1. A method of manufacture of an article comprising selective melting and/or sintering of a powder comprising an alloy containing aluminium, wherein the alloy contains bismuth.

2. A method according to claim 1, wherein an electron beam or a laser is used to selectively melt and/or sinter the powder.

3. A method according to claim 1 comprising selective laser melting and/or selective laser sintering.

4. A method according to claim 1, wherein aluminium is a major component of the alloy.

5. A method according to claim 1 wherein the alloy contains bismuth in an amount up to 10 wt %.

6. A method according to claim 1, wherein the alloy contains at least 0.2 wt % bismuth.

7. A method according to claim 1, wherein the alloy contains bismuth in an amount equal to or approaching its maximum liquid solubility in the alloy.

8. A method according to claim 1, wherein the alloy is an aerospace alloy, a casting alloy or a wrought alloy.

9. A method according to claim 1, wherein the alloy is an aluminium-silicon alloy.

10. A method according to claim 1, wherein the alloy contains scandium.

11. A method according to claim 1, wherein the alloy is a eutectic or near eutectic alloy.

12. A method according to claim 1, wherein the alloy is an AlSi12 alloy.

13. A method according to claim 1, wherein the alloy is a 6061 alloy.

14. A method according to claim 1, wherein the selective melting and/or sintering is carried out under an inert environment.

15. A method according to claim 1, wherein a laser power or electron beam power of 200 W or less is used.

16. A method according to claim 1, wherein a laser or electron beam scanning speed of no more than 400 mm/s is used.

17. A method according to claim 1, wherein a hatch distance of up to 1 mm is used.

18. A method according to claim 1, wherein a layer thickness of up to 100 μm is used.

19. A method according to claim 1, wherein the powder has an average particle size of up to 100 μm.

20. A method according to claim 1, wherein the method comprises the preliminary step of producing the powder.

21. A method according to claim 20, wherein the powder is produced by atomisation.

22. A method according to claim 1, wherein the article has a density of at least 85% theoretical density.

23. An article manufactured according to the method of claim 1.

24. A powder for use in the method of claim 1, the powder comprising an alloy containing aluminium, wherein the alloy contains bismuth.

25. A storage container connectable to an additive manufacturing apparatus, the container containing a powder according to claim 24.

26. A storage container according to claim 25 further containing an inert gas.

27. (canceled)
